(19) United States
(12) Patent Application Publication
(10) Pub. No.: US 2011/0095018 A1
(43) Pub. Date: Apr. 28, 2011

(54) Device For Producing A Single Crystal Composed Of Silicon By Remelting Granules

(75) Inventors: Wilfried von Ammon, Hochburg (AT); Ludwig Altmannshofer, Massing (DE); Andris Muiznieks, Riga (LV)

(73) Assignee: SILTRONIC AG, Munich (DE)

(21) Appl. No.: 12/910,906

(22) Filed: Oct. 25, 2010

(30) Foreign Application Priority Data
Oct. 28, 2009 (DE) 10 2009 051 010.9

(51) Int. Cl. H05B 6/10

(52) U.S. Cl. 219/632; 219/635

(57) ABSTRACT

A device for producing a silicon single crystal by remelting granules has a rotating plate of silicon having a central opening and having a silicon tubular extension which encloses the opening and extends below the plate; a first induction heating coil above the plate for melting granules; and a second induction heating coil below the plate for crystallizing the molten granules, wherein the second induction heating coil has, on its side lying opposite the silicon plate, a lower layer composed of a magnetically permeable material and an upper layer in which there is at least one cooling channel for conducting a coolant.

### CROSS-REFERENCE TO RELATED APPLICATION

This application claims priority to German Patent Application No. DE 10 2009 051 010.9 filed Oct. 28, 2009, which is herein incorporated by reference.

### BACKGROUND OF THE INVENTION

1. Field of the Invention

The invention relates to a device for producing a single crystal composed of silicon by remelting granules. The device comprises a rotating plate composed of silicon having a central opening and having a tubular extension composed of silicon that encloses the opening and extends below the plate, a first induction heating coil arranged above the plate for melting granules, and a second induction heating coil, arranged below the plate, for crystallizing the molten granules.

2. Background Art

The production of a single crystal by means of remelting granules is similar to the floating zone method (FZ method). The particular difference is that, instead of a polycrystalline feed rod composed of silicon, substantially polycrystalline granules composed of silicon are remelted. The granules can be obtained by precipitation in a fluidized bed. Dedicated induction heating coils (“inductor coils”) are used for melting the granules and for crystallizing the molten granules, the coils being situated respectively above and below a rotating plate composed of silicon. Granules fed to the plate composed of silicon are inductively melted there and flow as a film of liquid silicon through the central opening in the plate along the silicon tubular extension to a melt that forms on the end of the growing silicon single crystal.

At the start of the method, the tubular extension, which at this point in time is still closed off by a layer of solid silicon at its lower edge, is incipiently melted with the aid of the induction heating coil arranged below the plate, a small volume of liquid silicon arising. The lower edge of the tubular extension is brought to a shortest possible distance from the edge of the internal hole in the induction heating coil, in order that a high energy density can be inductively transmitted to the tubular extension and the forming volume of molten silicon. For this purpose, the induction heating coil arranged below the plate is displaced laterally. Afterward, a monocrystalline seed crystal is attached to the volume of molten silicon and, in accordance with the FZ method, firstly a thin neck, then a section of the single crystal that is extended conically as far as an end diameter, and finally a section having a constant desired diameter are crystallized. The requisite material of molten silicon is provided by partial melting of the tubular extension, by melting of the layer closing it off, by partial melting of the upper side of the plate and later by melting of granules composed of silicon. A melt forms which extends through the internal hole in the induction heating coil arranged below the plate. When the section having the constant desired diameter is crystallized, or if appropriate already beforehand, the induction heating coil and the melt are positioned relative to one another such that the melt extends substantially symmetrically through the internal hole in the induction heating coil.

DE 102 04 178 A1 describes a method and devices suitable therefor. Some of these devices comprise a water-cooled shielding plate composed of metal that is arranged between the plate composed of silicon and the second induction heating coil. It serves the purpose of shielding the plate composed of silicon from the electromagnetic field of the second induction heating coil and as a heat sink for dissipating heat from the plate composed of silicon.

During operation, the shielding plate is subjected to severe thermal loading, with the consequence that it tends to curve. If in response to this the shielding plate is made thicker in order to avoid curving, or enough space is left axially in order that the shielding plate can curve without touching the second induction heating coil or the plate composed of silicon, there is the risk of the melt freezing solid at the end of the tubular extension, the film of continuous flowing silicon being thereby interrupted.

### SUMMARY OF THE INVENTION

It is an object of the present invention to eliminate the problems described above without disadvantageous consequences. These and other objects are achieved by means of a device for producing a silicon single crystal by remelting granules, comprising a rotating silicon plate having a central opening and having a tubular silicon extension which encloses the opening and extends below the plate; a first induction heating coil arranged above the plate for melting granules; and a second induction heating coil arranged below the plate for crystallizing the molten granules, wherein the second induction heating coil has, on its side opposed to the silicon plate, a lower layer composed of a magnetically permeable material and an upper layer in which there is at least one cooling channel for conducting a coolant.

### BRIEF DESCRIPTION OF THE DRAWINGS

FIG. 1 illustrates a particularly preferred embodiment of the inventive device in cross section in a phase in which a small volume of liquid silicon is formed at the lower edge of the tubular extension of the plate.

FIG. 2 illustrates a device in accordance with FIG. 1 in a phase in which that section of the single crystal which has a constant desired diameter is crystallized.

### DETAILED DESCRIPTION OF THE PREFERRED EMBODIMENT(S)

The rotating plate has a central opening and a tubular extension composed of silicon that encloses the opening and extends below the plate. The second induction heating coil has, on its side lying opposite the silicon plate, i.e. facing the silicon plate, a lower layer composed of a magnetically permeable material and an upper layer, in which there is at least one cooling channel for conducting a coolant. The second induction heating coil is preferably produced from silver or from copper. The lower layer is in direct thermal contact with the second induction heating coil, and the upper layer is in direct thermal contact with the lower layer. The upper layer and the second induction heating coil are directly electrically isolated from one another. Slots can be incorporated into that edge of the upper layer which lies around the internal hole in the second induction heating coil in order to counteract the situation where the second induction heating coil inductively couples into this region of the upper layer. A coolant, for example water, flowing through the cooling channel of the upper layer cools the lower side of the rotating plate that lies opposite the second induction heating coil. A material having good thermal conductivity, for example a metal or a ceramic, is preferably taken into consideration as a material that forms the upper layer. A metallic material that has good thermal conductivity and does not adversely affect the electrical properties of the silicon as semiconductor material is particularly preferred. Silver and copper are particularly suitable. The upper layer should radiate as little heat as possible to the plate lying opposite. It is preferred, therefore, to blacken the upper layer on the side lying opposite the plate.

A further preferred feature of the upper layer is a cutout in the region of the internal hole in the induction heating coil, for example a V-shaped or elliptical cutout, which is preferably arranged in opposite fashion with respect to the power supply line of the induction heating coil. The cutout enables a short distance and thus an effective inductive coupling between the inductive heating coil and the tubular extension of the plate. It thereby becomes simpler to form the small volume of molten silicon to which the seed crystal is attached at the start of the production method. If the cutout is present, the upper layer cools the tubular extension of the plate and the adjoining region of the plate less effectively. In order to compensate for this disadvantage, there is present in the second induction heating coil at least one nozzle through which can be conducted a gas for cooling the tubular extension and an adjoining region of the plate. As far as the lower layer is concerned, a ferromagnetic plastic, for example a thermoplastic containing soft iron particles, is preferably taken into consideration as a magnetically permeable material. U.S. Pat. No. 4,486,641 describes that such materials can be used as coating of induction heating coils in order to control the direction and intensity of the magnetic flux. The lower layer concentrates the magnetic field generated by the second induction heating coil onto the close surroundings of the induction heating coil, in particular onto that region of the melt which is closest to the internal hole in the induction heating coil.

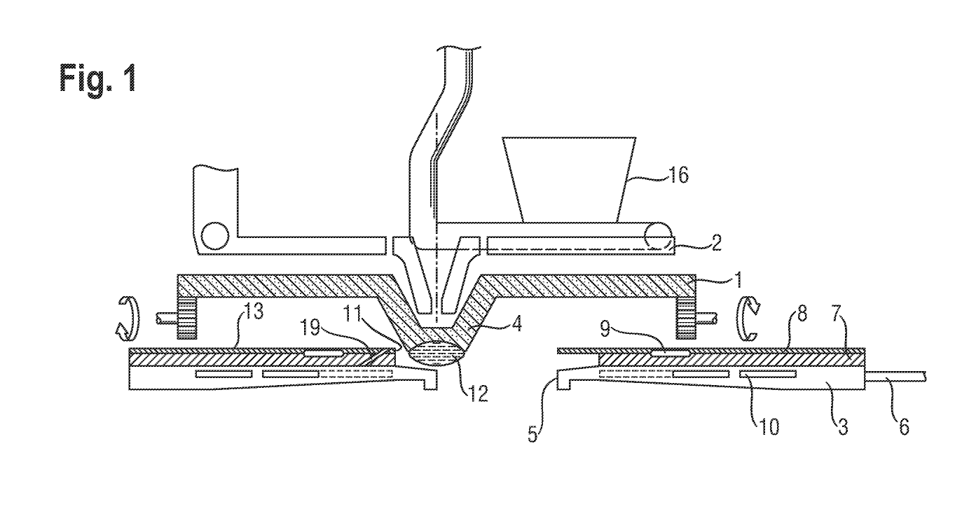

The device shown in FIG. 1 comprises a rotating plate 1 composed of silicon, a first induction heating coil 2 arranged above the plate 1, and a second induction heating coil 3 arranged below the plate. The rotating plate 1 has a central opening and a tubular extension 4 composed of silicon that encloses the opening and extends below the plate 1. The first induction heating coil 2 preferably has the features of the induction heating coil described in DE 10 2008 013 326 A1. The second induction heating coil 3 is embodied as a flat coil having a central internal hole 5. It is supplied with electrical power from one side via power supply lines 6. The second induction heating coil 3, on the side lying opposite the plate 1, is coated with a lower layer 7 composed of a magnetically permeable material. The magnetically permeable material preferably comprises a plastic which concentrates the magnetic flux and which is offered under the trade name Fluxtrol®. Situated on the lower layer is an upper layer 8, in which there is at least one cooling channel 9 for conducting a coolant and which preferably comprises silver or copper. It is also preferred for the induction heating coil 3 to have at least one cooling channel 10 for conducting a coolant.

It is furthermore preferred for the upper layer 8 to have a cutout 11 at its edge in the region of the internal hole 5 in the induction heating coil and on the opposite side with respect to the power supply lines 6. The cutout 11 permits a short distance between the induction heating coil 3 and the tubular extension 4 in the phase in which a small volume 12 of liquid silicon is formed at the lower edge of the tubular extension 4 of the plate 1. The cutout 11 is preferably formed in V-shaped fashion or elliptically, for example.

Slots can be incorporated into that edge of the upper layer 8 which lies around the internal hole 5 in the second induction heating coil 3 in order to counteract the situation where the second induction heating coil inductively couples into this region of the upper layer.

It is furthermore preferred for the upper layer 8 to be blackened on the side 13 lying opposite the plate 1.

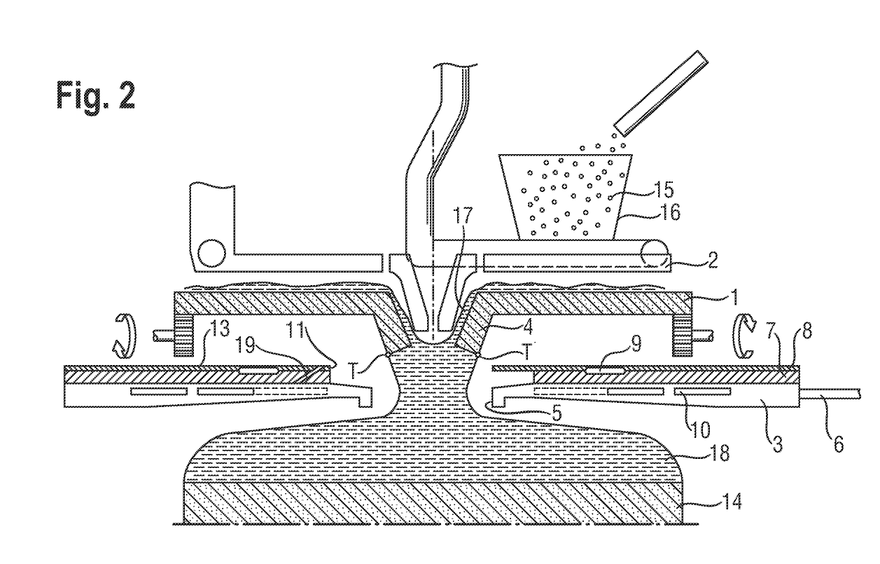

FIG. 2 illustrates the phase in which that section of the single crystal 14 which has a constant desired diameter is crystallized. In this phase, granules 15 are conveyed through a funnel 16 to the plate 1 composed of silicon and are melted with the aid of the first induction heating coil 2. They flow as a film 17 of molten silicon through the tubular extension 4 to a melt 18 that lies on the growing single crystal 14 and is crystallized continuously. In this phase, the tubular extension 4 and the adjoining region of the plate in the vicinity of the cutout 11 are heated to a comparatively great extent by the second induction heating coil 3. As a result, there is the risk of the tubular extension 4 composed of silicon starting to melt excessively at its lower end and the triple point T migrating upward until the melt 18 is overstretched and the contact with the lower end of the tubular extension 4 breaks away. In order to avoid this, it is preferred to cool the tubular extension 4 composed of silicon and the adjoining region of the plate 1 with a gas, for example with argon. The gas is conducted through at least one nozzle 19 arranged in the induction heating coil.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A device for producing a single crystal composed of silicon by remelting silicon granules, comprising
a rotating silicon plate having a central opening and having a tubular silicon extension which encloses the opening and extends below the plate;
a first induction heating coil arranged above the plate for melting granules; and
a second induction heating coil arranged below the plate for crystallizing the molten granules, wherein the second induction heating coil has, on its side opposed to the silicon plate, a lower layer comprising a magnetically permeable material, and an upper layer in which there is at least one cooling channel for conducting a coolant.

2. The device of claim 1, wherein the lower layer comprises a ferromagnetic plastic.

3. The device of claim 1, wherein the upper layer comprises a metallic material.

4. The device of claim 2, wherein the upper layer comprises a metallic material.

5. The device of claim 1, wherein the second induction heating coil and the upper layer comprise silver or copper.

6. The device of claim 1, wherein the second induction heating coil has at least one cooling channel for conducting a coolant.

7. The device of claim 1, wherein the upper layer has a cutout at its edge in a region of an internal hole in the second induction heating coil and on an opposing side with respect to power supply lines of the second induction heating coil, and the second induction heating coil has at least one nozzle for cooling the tubular silicon extension and an adjoining region of the plate with a gas.

8. The device of claim 1, wherein the upper layer is blackened on the side lying opposite the silicon plate.
